(19) United States
(12) Patent Application Publication
(10) Pub. No.: US 2008/0223460 A1
(43) Pub. Date: Sep. 18, 2008

(54) POPPET CHECK VALVE FOR HIGH PRESSURE OIL PUMP

(75) Inventor: Vladimir Pecheny, Arlington Heights, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/687,129

(22) Filed: Mar. 16, 2007

(51) Int. Cl. F16K 21/04

(52) U.S. Cl. 137/543.19

(57) ABSTRACT

A poppet valve assembly (118) for a piston-type fluid pump (10) having a longitudinal axis (A) and also having a plug (136) that defines a spring housing (135), includes a poppet (122). The poppet (122) has a first portion (126) and a second portion (128) of increased height, with the second portion (128) being disposed on the first portion (126). A spring (130) forms at least one coil and is disposed in the spring housing (135). The spring (130) has a first end (132) freely disposed around the second portion (128) of the poppet (122), and the first end (132) is annularly spaced around the second portion (128) in a direction generally perpendicular to the longitudinal axis (A). A seat insert (124) is also included that is configured for reciprocally receiving the poppet (122).

### FIELD OF THE INVENTION

The present invention relates generally to high pressure piston/plunger type fluid pumps, and particularly, to a poppet check valve for a high pressure oil pump on an engine.

### BACKGROUND OF THE INVENTION

As is well-known to those skilled in the automotive art, but also known by those in other arts, mechanical assemblies often require high pressure fluid for optimal hydraulic control, and for reliable performance of hydraulically actuated and controlled fuel injectors and/or other actuators. Typical examples where this need for high pressure oil supply is especially important in automotive vehicles include piston engines, transmissions, and other drivetrain components. Commonly, high-pressure oil flow is provided to these components with a high-pressure piston/plunger type fluid pump that produces an outflow of compressed fluid. The outflow of fluid is then directed to a number of hydraulically actuated fuel injectors and/or vehicle steering actuators.

Traditionally, mechanically driven piston/plunger type fluid pumps are provided for high-pressure oil systems of automotive vehicle components. The fluid pump is usually mounted directly onto or adjacent to a drivetrain component, and power is provided to the pump from rotating drive members in the component. A variety of drive systems have been employed to power fluid pumps, with one common example including an input drive gear that is connected to a camshaft that extends into the fluid pump. The input drive gear is driven by another gear that is associated with the drivetrain component.

To separate the compression and suction strokes of the piston/plunger type high-pressure oil pump and reach high hydraulic performance of the pumping process, a poppet check valve is typically mounted at an outlet of a piston/plunger compression chamber. The poppet check valve regulates the one-way direction of the pressurized oil flow by putting the compression chamber and the high-pressure oil gallery in fluid communication with each other only during a portion of a compression stroke of the piston/plunger. The opening and closing of the poppet check valve is a function of the pressure differential between the compression chamber and a high-pressure oil gallery.

As the piston/plunger moves deeper into compression the chamber by a driving force from the cam of the rotating camshaft, the pressure in the compression chamber becomes larger than the pressure in the high-pressure oil gallery. When a predetermined pressure differential has been reached, the poppet valve opens against a spring force and a hydraulic force from the oil gallery pressure force to place the compression chamber and the high-pressure oil gallery in fluid communication with each other. As a result, the compressed oil from the gallery exits the compression chamber and enters into the oil gallery. Oil continues to exit the compression chamber while the piston/plunger is in its compression stroke. When the piston/plunger reaches a point of maximum compression stroke it reverses direction and begins to retract. The piston/plunger starts to move back and the pressure in the compression chamber is equalized or slightly reduced against the oil gallery pressure, causing the spring force to push the poppet check valve back down to seal against a valve seat.

Nonetheless, proper sealing of the poppet check valve with the valve seat does not always occur. One reason proper sealing does not occur is that the poppet check valve sometimes disengages from the spring and becomes misaligned with the valve seat. Moreover, the poppet check valve drops onto the valve seat with high acceleration, under some conditions, and tends to “bounce” off the seat. The “bouncing” creates a different reflective force on the poppet check valve as compared with the reflective force on the spring member. As a result, the spring member tends to separate from the poppet check valve or alternately, tends to undergo material failure, and the poppet check valve becomes misaligned from the valve seat.

When the poppet check valve becomes misaligned from the seat, the high-pressure oil pump is unable to pump the compressed oil flow to oil gallery due to the back-flow of oil from the gallery back into the compression chamber during the suction stroke. As a result, the pump loses the hydraulic performance, the oil high pressure is dropped and the engine loses performance.

Thus, there is a need for a poppet check valve assembly that reduces the likelihood of the poppet check valve becoming misaligned from the seat.

There is also a need for poppet check valve assembly that will have prolonged life.

### SUMMARY OF THE INVENTION

A check valve assembly includes a check valve pilot. The check valve pilot has a first portion of decreased height and a second portion of increased height, with the second portion being disposed on top of the first portion. A spring member forms a coil and is disposed in the spring housing. The spring member has a first end freely disposed around the second portion of the check valve pilot, and the coil is annularly spaced from the second portion in a direction generally perpendicular to the longitudinal axis. A seat structure is also included that is configured for reciprocably receiving the check valve pilot.

### BRIEF DESCRIPTION OF THE DRAWINGS

FIG. 1 is a plan section view of a high-pressure oil pump mounted on an engine.

FIG. 2 is a plan section view of a prior art poppet check valve assembly in the seated position.

FIG. 3 is a plan section view of the prior art poppet check valve assembly in a disengaged position.

FIG. 4 is a plan section view of a first embodiment of poppet check valve assembly mounted on a seat of a compression chamber in accordance with the invention.

FIG. 5 is a plan section view of the first embodiment of poppet check valve assembly in accordance with the invention.

FIG. 6 is a plan section view of a second embodiment of poppet check valve assembly mounted on a seat of the compression chamber in accordance with the invention.

FIG. 7 is a plan section view of the second embodiment of poppet check valve assembly in accordance with the invention.

FIG. 8A is a plan view of a poppet check valve plug of the second embodiment in accordance with the invention.

FIG. 8B is a section view of the poppet check valve plug in the direction indicated in FIG. 8A in accordance with the invention.

### DESCRIPTION OF A PREFERRED EMBODIMENT

Referring to FIG. 1 through FIG. 3, a prior art high-pressure oil pump is indicated generally at 10. The pump 10 includes a compression chamber 16 that is in fluid communication with a poppet check valve assembly 18. During operation of the pump 10, oil flows into the compression chamber 16 from an inlet opening 12, where it is compressed by a piston 20 powered by rotating drive members on a cam 21. In the pump of FIG. 1, there are six pistons and poppet check valve assemblies 18, with three on each side of the pump 10.

The poppet check valve assembly 18 includes a poppet 22 and a seat insert 24. The poppet 22 is generally annular and has a first annular portion 26. A second annular portion 28 having a diameter smaller than a diameter of the first annular portion 26 is disposed generally centrally on one side of the first annular portion 26. A spring 30 has a first end 32 disposed around the second portion 28 of the poppet 22. In the prior art poppet check valve assembly 18, the first end 32 of the spring 30 is typically press fit around the second portion 28 of the poppet 22 with a force of about 9-10 Newton (N).

The spring 30 is received into a spring housing 35 that is formed in a plug 36. The plug 36 is generally cylindrical with an enclosed end 38, and is received in a generally annular sleeve 40 of the pump 10. A second end 42 of the spring 30 rests against the enclosed end 38 of the plug 36.

The seat insert 24 is generally annular with a cylindrical cavity 44 disposed through the center of the seat insert 24 along a longitudinal axis “A” of the poppet check valve assembly 18. A first portion 46 of the seat insert 24 forms a seat surface 50 that is configured to sealably engage the poppet 22. The cylindrical cavity 44 is in fluid communication with the compression chamber 16, at times when the poppet 22 is not engaged against the seat surface 50, such that oil can flow up into the cylindrical cavity 44.

The seat surface 50 of the seat insert 24 surrounds an outlet opening 52 of the compression chamber 16. When the poppet 22 is seated on the seat surface 50, the compression chamber 16 is sealed from a high-pressure oil gallery 54, which is connected to an outlet 56 of the pump 10. When the poppet 22 is unseated from the seat surface 50, the cylindrical cavity 44 is in fluid communication with the high-pressure oil gallery 54 and the outlet 56.

The poppet check valve assembly 18 controls the oil flow direction inside the high-pressure oil pump 10. Specifically, the poppet check valve assembly 18 regulates the direction of the high pressure flow by use of a pressure differential between the compression chamber 16 and the high-pressure oil gallery 54 by selectively seating and unseating the poppet 22 against the seat surface 50, putting the compression chamber 16 and the high-pressure oil gallery 54 in fluid communication with each other during a compression stroke of the piston 20, and fluidly sealing them during a suction stroke of the piston 20.

Oil in the compression chamber 16 is compressed by the piston 20 that reciprocates within a piston bore 58 through the motion of the cam 21. As the piston 20 moves towards the seat insert 24, a piston spring 60 is compressed, and the oil is compressed by reducing a volume of the compressing chamber 16 while the poppet 22 is seated on the seat surface 50. Seating of the poppet 22 against the seat surface 50 is maintained by forces acting on the poppet 22 by the spring 30 as well as a hydraulic force from oil in the high pressure oil gallery 54.

At times when a predetermined pressure differential is achieved between oil pressure in the compression chamber 16 and oil pressure in the high pressure oil gallery 54, the poppet valve assembly 18 opens against the spring 30 to place the compression chamber 16 and the high-pressure oil gallery 54 in fluid communication with each other. When the pressure in the compression chamber 16 is reduced, the spring 30 overcomes a pressure differential required to unseat the poppet 22 and pushes the poppet 22 toward the seat surface 50.

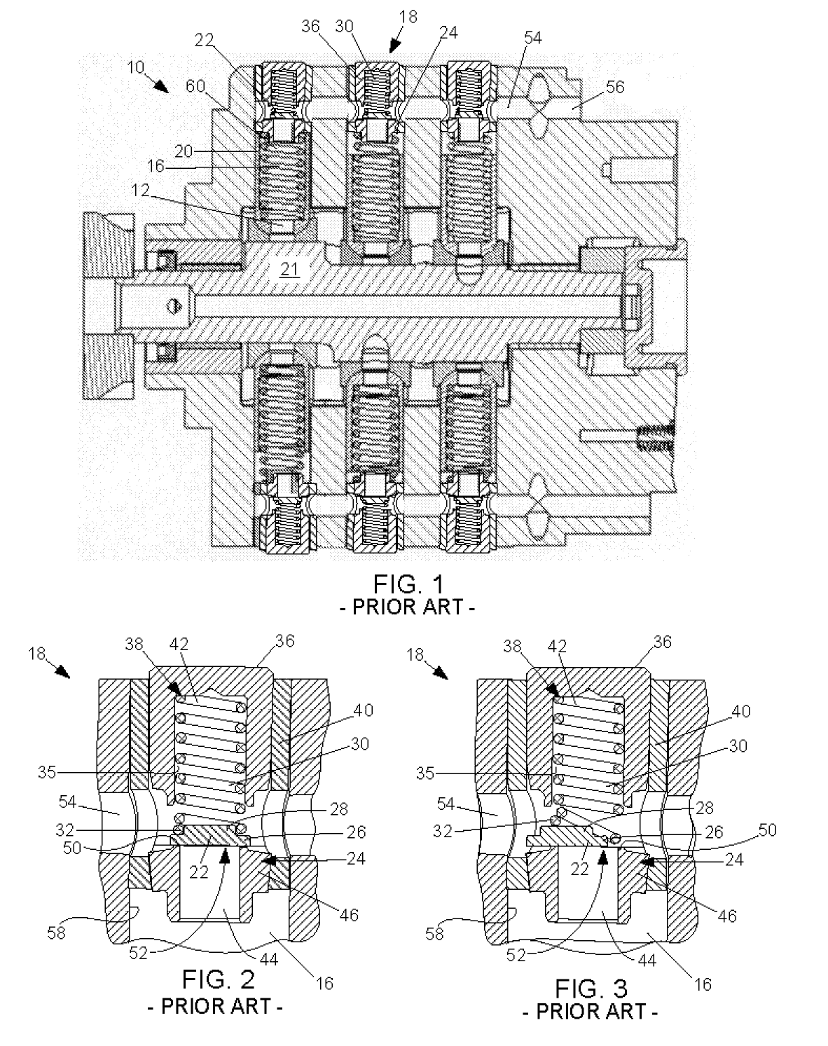

In normal operation of the prior art oil pump 10, the poppet 22 will seat in the seat surface 50 as seen in FIG. 2. However, as seen in FIG. 3, in some instances the poppet 22 will become disengaged from the spring 30 and not seat itself on the seat surface 50. When the poppet 22 drops onto the seat insert 24, it drops with high acceleration and tends to “bounce” on the seat surface 50 before fully seating. The “bouncing” creates a different reflective force on the poppet 22 than on the spring 30 because the two components have different masses. As a result, the spring 30 losses its press fit connection and becomes disengaged from the poppet 22, or alternately, the spring 30 and/or the poppet 22 fracture(s) or otherwise fail(s).

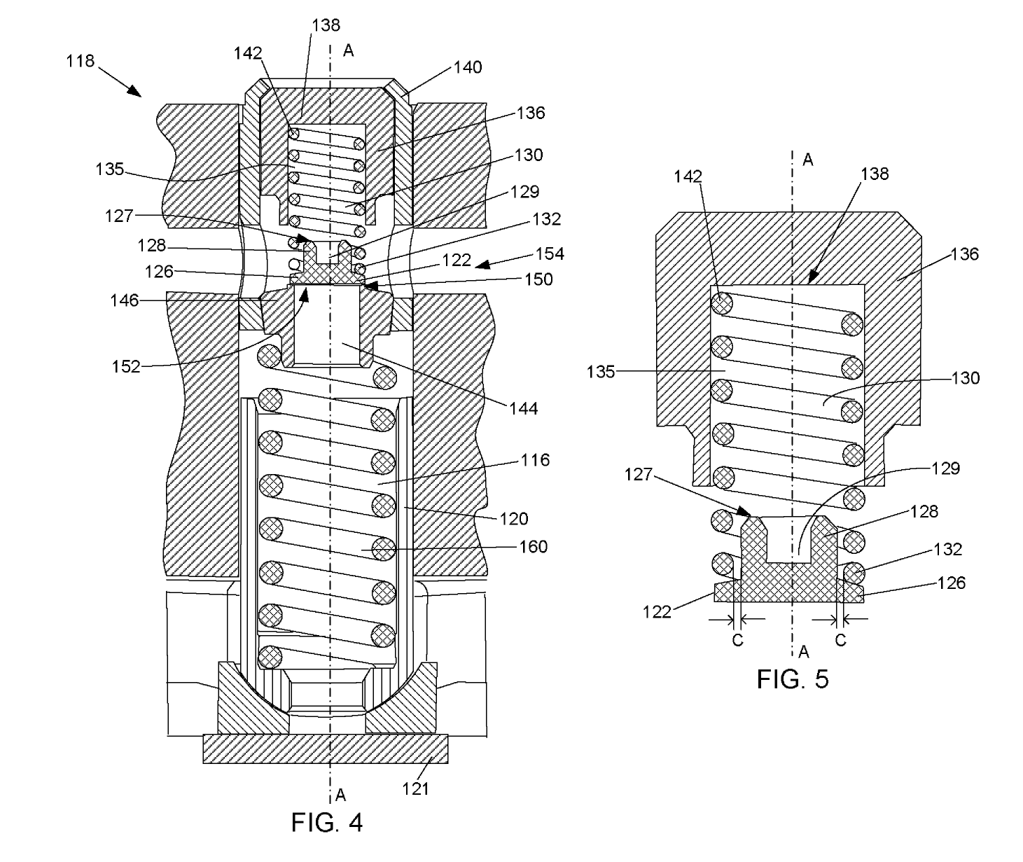

Referring now to FIG. 4 and FIG. 5, a first embodiment of an improved poppet valve assembly is indicated generally at 118. The poppet valve assembly 118 is advantageously capable of remaining aligned with a seat insert 124. Components that are similar to the prior art poppet valve assembly 18 are designated with identical reference numbers in the 100-series.

The poppet valve assembly 118 includes a poppet 122 that sealably associated with the seat insert 124. The poppet 122 is generally annular and has a first portion 126, and a second portion 128 having a smaller diameter than the first portion 126. The second portion 128 is disposed generally centrally on the first portion 126. While the poppet 122 is shown having an annular shape, other shapes are envisioned that provide sufficient length to seal with the seat insert 124. Further, the first portion 126 advantageously has a decreased height, compared to the prior art, and the second portion 128 advantageously has an increased height in a direction parallel to a longitudinal axis “A”.

In comparison to the prior art poppet valve assembly 18 of FIG. 1 through FIG.3, the second portion 128 of the poppet 122 has an increased extension or height, relative to the first portion 126, that is parallel to the longitudinal axis “A”. Specifically, the second portion 128 advantageously has a height that is generally greater than twice the height of the first portion 126, and more advantageously, may have a height that is at least three times the height of the first portion 124. Further, the second portion 128 advantageously has a height sufficient to maintain the poppet 122 within a first end 132 of a spring 130. In this embodiment, the second portion 128 extends away from the first portion 126 enough to be surrounded by at least two coils of the spring 130.

The second portion 128 also includes a recess 129 to reduce the overall mass of the poppet 122. Preferably, the poppet 122 is generally symmetric about the longitudinal axis “A”.

The first end 132 of the spring 130 is disposed around the second portion 128 of the poppet 122. In contrast to the prior art, the first end 132 of the spring 130 is not press fit or attached in any way to the poppet 122. Instead, the first end 132 sits on the first portion 126 and is freely disposed around the second portion 128 with an annular clearance “C” between the spring 130 and the second portion 128 in a direction generally perpendicular to the longitudinal axis “A”. In this way, the spring 130 is not positively attached to the poppet 122.

The spring 130 is received into a spring housing 135 that is formed in a plug 136. The plug 136 is received in a generally annular sleeve 140. A second end 142 of the spring 130 rests against an enclosed end 138 of the plug 136, and can alternatively be attached to the enclosed end 138.

The seat insert 124 is generally annular with a cylindrical cavity 144 disposed through the center of the seat insert 124 along the longitudinal axis “A”. A first portion 146 of the seat insert 124 forms a seat surface 150 that is configured to sealably engage the poppet 122. The cylindrical cavity 144 is in fluid communication with a compression chamber 116.

The operation of the poppet valve assembly 118 is similar to the operation of the poppet valve assembly 18 of the prior art. The seat surface 150 surrounds an outlet opening 152 that fluidly communicates with the compression chamber 116. When the poppet 122 is seated on the seat insert 124, the compression chamber 116 is substantially sealed from a high-pressure oil gallery 154, which is connected to a flow outlet 156. Oil in the compression chamber 116 is compressed by a piston 120 that reciprocates within the compression chamber 116 by the motion of a cam 121. As the piston 120 moves towards the seat insert 124, a piston spring 160 is compressed, and oil inside the compression chamber 116 is compressed.

At times when a predetermined pressure differential is achieved between oil pressure in the compression chamber 116 and oil pressure in the high pressure oil gallery 154, the poppet 122 opens against the spring 130 to place the compression chamber 116 and the high-pressure oil gallery 154 in fluid communication with each other. When the pressure in the compression chamber 116 is reduced, the spring 130 pushes the poppet 122 down to seal with the seat surface 150, and the piston spring 160 pushes the piston 120 away from the seat insert 124.

The poppet 122 is advantageously less likely to become misaligned with the seat insert 124. The free, first end 132 advantageously allows the spring 130 and the poppet 122 to each “bounce” independently from each other in accordance with their masses after impacting the seat insert 124. The “bounce” of the spring 130 is advantageously less influenced by the motion of the higher mass of the poppet 122, and is thus less likely to fracture (or otherwise fail), or disengage from the poppet 122.

Further, since the second portion 128 of the poppet 122 is elongated, it is more likely to stay disposed within the first end 132 of the spring 130. Advantageously, a top surface 127 of the second portion 128 may be rounded to guide the spring 130 around the second portion 128. In this configuration, the spring 130 advantageously aligns the poppet 122 with the seat surface 150 without being attached to the poppet 122.

While the embodiment described thus far includes the elongated second portion 128 to permit alignment of the poppet 122 without attaching the spring 130 thereto, it is contemplated that other configurations of poppets may be used. For example, the poppet 122 may have an elongated portion external to the spring member, such as a peripheral lip (not shown), that still maintains a clearance with the spring 130. Alternately, a surface of the poppet may be provided with recesses that receive the spring 130, yet allow for independent movement of the spring with respect to the poppet.

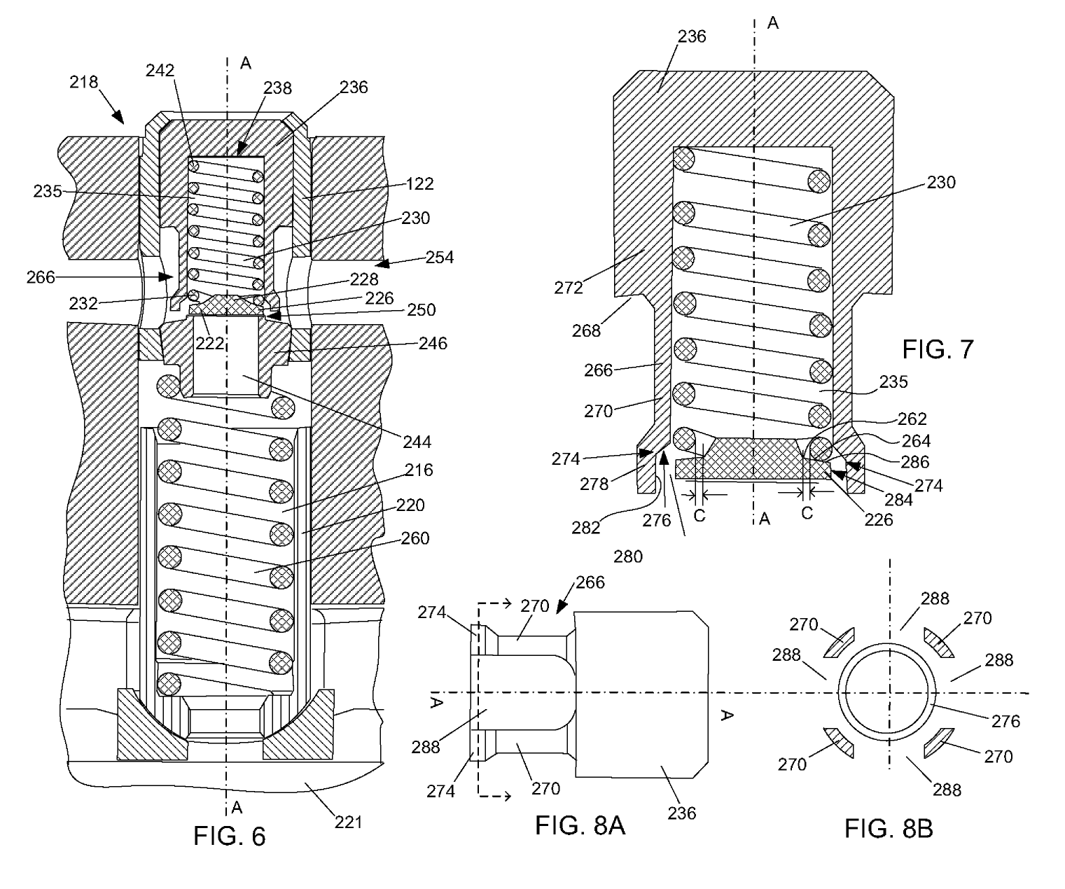

Referring now to FIG. 6 through FIG. 8B, an alternate embodiment for a poppet valve assembly is indicated generally at 218. Components that are similar to the prior art poppet valve assembly 18 are designated with identical reference numbers in the 200-series.

Similar to the prior art poppet check valve assembly 18 of FIG. 1 through FIG. 3, the poppet valve assembly 218 includes a poppet 222 and a seat insert 224. In this embodiment, the poppet 222 is generally annular, has a first portion 226, and a second portion 228 of that has a decreased diameter with respect to a diameter of the first portion 226. The second portion 228 is disposed generally centrally on the first portion 226. While the check valve pilot 222 shown has an annular shape, other shapes are envisioned that provide sufficient area (perpendicular to the longitudinal axis “A”) to seal with the seating insert 224. Further, the first portion 226 is lower than the second portion 228 in a direction parallel to the longitudinal axis “A”.

A spring 230 has a first end 232 that is received on a receiving surface 264 of the poppet 222. The receiving surface 264 is formed on the first portion 226 surrounding an interface between the first portion 226 and the second portion 228, and is configured to receive the first end 232 of the spring 230. The spring 230 is not attached to the receiving surface 264 but simply rests in contact therewith. In this embodiment, the first end 232 is disposed around the second portion 228 of the check poppet 222. Similar to the embodiment described above, the first end 232 of the spring 230 is not attached to second portion 228 of the poppet 222. Instead, the first end 232 is freely and concentrically disposed around the second portion 228 with an annular clearance “C” between the spring 230 and the second portion 228 in a direction generally perpendicular to the longitudinal axis “A”.

The second end 242 of the spring 230 is received into enclosed end 238 of a spring housing 235. The spring housing 235 is formed in a plug 236 that is received in a sleeve 240.

The seat insert 224 is also generally annular with a cylindrical cavity 244 disposed through the center thereof and along a longitudinal axis “A”. The cylindrical cavity 244 is in fluid communication with a compression chamber 216. A seat surface 250 is formed on the seat insert 224.

At times when a predetermined pressure differential is achieved between oil pressure in the compression chamber 216 and oil pressure in a high pressure oil gallery 254, the poppet 222 opens against the spring 230 to place the compression chamber 216 and the high-pressure oil gallery 254 in fluid communication with each other. When the pressure in the compression chamber 216 is reduced, the spring 230 pushes the poppet 222 down to seal with the seat surface 250, and a piston spring 260 pushes a piston 120 reciprocally disposed in the compression chamber 216 away from the seat insert 224.

In this alternate embodiment of the poppet valve assembly 218, a guide 266 is formed adjacent to a valve end 268 of the plug 236, and is configured to mechanically guide and stop the poppet 222. The guide 266 includes an extension 270 that extends from a body 272 of the plug 236 generally along the longitudinal axis “A” and away from the enclosed end 238. The extension 270 forms an extension of the spring housing 235 formed in the body 272 along the length of the spring 230 to advantageously contain therein a greater portion of the spring 230 as compared to the prior art. The spring 230 is substantially contained within the extension 270 and the spring housing 235, and the guide 266 extends from the body 272 of the plug 236 substantially to the seat insert 224 in a direction parallel to the longitudinal axis “A”. While the embodiment described thus far for the extension portion 270 has a reduced diameter compared to the body 272, it is contemplated that the extension portion can have an equal or greater diameter than the body 272.

The guide 266 also includes a stop 274 formed therein and disposed adjacent to a distal end of the extension 270 that is closest to the seat insert 224 when assembled. The stop 274 advantageously forms an engaging surface 276 and a side extension 278. The side extension 278 forms an enlarged opening 280 to the spring housing 235. The spring housing 235 forms a guiding surface 282 in the area of the side extension 278 that is generally parallel to the longitudinal axis “A”.

As seen in FIG. 7, when the poppet 222 is pushed off the seat surface 250, the side extension 278 captures the poppet 222 within the guiding surface 282 as the poppet moves generally away from the seat insert 224 in a direction parallel to the longitudinal axis “A”. The stop 274 stops the motion of the poppet 222 when the poppet 222 engages the engaging surface 276. Specifically, the first portion 226 of the poppet 222 has a peripheral surface 284 that is aligned by the guiding surface 282, and further, the first portion 226 has an upper surface 286 that engages the engaging surface 276 of the stop 274. In this configuration, the poppet 222 is less likely to become misaligned from the seat insert 224.

Referring to FIGS. 8A and 8B, the guide 266 includes four extensions 270 disposed generally around the spring 230. Removed areas 288 are located between the extensions 270 to permit the flow of oil through the high-pressure oil gallery 254 and out to the outlet 256. However, other configurations of the extensions 270 are envisioned. For example, there can be one extension 270 provided with apertures, or there can be any number of extension portions. Further, any mechanical structure extending around the spring 230 that forms a mechanical stop but also permits the flow of oil through the high-pressure oil gallery 254 from one side of the poppet valve assembly 218 to the other is contemplated.

The free, first end 232 of the spring 230 is not affixed to the poppet 222 to advantageously allow the spring 230 and the poppet 222 to each “bounce” independently from each other after the poppet 222 impacts the seat surface 250. It is contemplated that the elongated second portion 128 of the poppet valve assembly 118 described above can be combined with the guide 266 of the poppet valve assembly 218 to further increase the likelihood maintaining alignment of the poppet 222 with the spring 230 and the seat insert 224.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A poppet valve assembly for a piston-type fluid pump having a longitudinal axis and a plug defining a spring housing, comprising:
a poppet having a first portion and a second portion disposed on the first portion, wherein the second portion has a smaller diameter than the first portion;
a spring forming a coil and disposed in the spring housing, wherein the spring has a first end freely disposed around the second portion of the poppet, wherein the coil is annularly spaced from the second portion in a direction generally perpendicular to the longitudinal axis; and
a seat surface formed on a seat insert such that the seat surface is configured to reciprocally and sealably engage the poppet.

2. The poppet valve assembly of claim 1, wherein the second portion has a height that is generally greater than two times a height of the first portion.

3. The poppet valve assembly of claim 1, wherein the second portion has a height that is at least three times the height of the first portion.

4. The poppet valve assembly of claim 1, wherein the spring forms at least a second coil, and wherein the second portion is surrounded by the coil and the second coil of the spring.

5. The poppet valve assembly of claim 1, further comprising a guide disposed on a distal end of the plug that is adjacent to the poppet, wherein the guide is configured to mechanically guide and stop the poppet.

6. The poppet valve assembly of claim 5, wherein the guide forms an extension that extends away from a body of the plug in a direction generally parallel to the longitudinal axis.

7. The poppet valve assembly of claim 6, wherein the spring housing extends through the extension, and wherein the spring is substantially entirely disposed in the spring housing.

8. The poppet valve assembly of claim 6, wherein the guide includes a stop disposed adjacent to a distal end of the extension.

9. The poppet valve assembly of claim 7, wherein the stop forms an engaging surface disposed on a side extension thereof, wherein the engaging surface surrounds an enlarged opening to the spring housing.

10. The poppet valve assembly of claim 9, wherein the side extension of the stop is generally parallel to the longitudinal axis and is configured for guiding the poppet such that the poppet engages the engaging surface.

11. A poppet valve assembly for a fluid pump, the poppet valve assembly having a longitudinal axis and a plug defining a spring housing, comprising:
a poppet including a first portion having a first height and a second portion having a second height that is greater than the first height, wherein the second portion is disposed on the first portion;
a spring that forms a coil, wherein the spring is disposed in the spring housing, wherein the spring has a first end disposed generally concentrically with the poppet, wherein the coil is annularly spaced around and away from the second portion in a direction generally perpendicular to the longitudinal axis; and
a seat insert configured for reciprocally receiving the poppet such that the poppet sealably engages a seat surface formed on the seat insert.

12. The poppet valve assembly of claim 11, wherein the second portion is disposed generally centrally on the first portion, and wherein the coil is disposed generally concentrically around the second portion of the poppet.

13. The poppet valve assembly of claim 11, wherein the second height is greater than two times the first height.

14. The poppet valve assembly of claim 11, wherein the second height is at least three times the first height.

15. The poppet valve assembly of claim 11, wherein the second portion is surrounded by at least a second coil that is formed by the spring.

16. A poppet valve assembly for a fluid pump having a longitudinal axis and a check valve plug defining a spring housing, comprising:
a spring forming a coil and disposed in the spring housing, wherein the spring has a first end;
a poppet having a receiver that is configured to receive the first end of the spring;
a seat configured for reciprocally receive the poppet; and
a guide connected to the plug and configured to mechanically guide and stop the poppet, wherein the guide extends from a body portion of the plug substantially to the seat in a direction parallel to the longitudinal axis.

17. The poppet valve assembly of claim 16, wherein the spring is not attached to the poppet in a direction generally perpendicular to the longitudinal axis.

18. The poppet valve assembly of claim 16, wherein the guide includes an extension, wherein the spring housing extends into the extension, and wherein the spring is contained substantially entirely within the spring housing.

19. The poppet valve assembly of claim 18, wherein the guide includes a stop disposed adjacent to a distal end of the extension, wherein the stop includes an engaging surface and a side extension disposed generally perpendicular to the engaging surface, and wherein the engagement surface forms an enlarged opening to the spring housing.

20. The poppet valve assembly of claim 19, wherein the side extension is generally parallel to the longitudinal axis and is configured for guiding the poppet into engagement with the engaging surface.
